(19) United States
(12) Patent Application Publication
(10) Pub. No.: US 2026/0365516 A1
(43) Pub. Date: Nov. 19, 2026

(54) LFP CATHODE MATERIAL FOR LITHIUM-ION BATTERIES, LIQUID-FREE SYNTHESIS METHOD THEREOF AND APPLICATION THEREOF

(71) Applicant: Xin ZHANG, Grand Forks, ND (US)

(72) Inventors: Xin ZHANG, Grand Forks, ND (US); Yong HOU, Grand Forks, ND (US)

(73) Assignee: Xin ZHANG, Grand Forks, ND (US)

(21) Appl. No.: 19/209,848

(22) Filed: May 16, 2025

(51) Int. Cl. C01B 25/45; H01M 10/0525

(52) U.S. Cl. CPC C01B 25/45; H01M 10/0525; C01P 2002/52; C01P 2002/72; C01P 2004/03; C01P 2004/51; C01P 2004/61; C01P 2004/84; C01P 2006/11; C01P 2006/12; C01P 2006/40

(57) ABSTRACT

A method for liquid-free synthesis of a lithium iron phosphate (LFP) cathode material based on resonant acoustic mixing (RAM) technology is provided, including: providing precursor materials comprising lithium carbonate, iron phosphate, a carbon source, and a reduction agent, mixing and pulverizing the precursor materials using a resonant acoustic mixer without employing a liquid medium, performing a heat treatment on pulverized precursor materials in a nitrogen-atmosphere furnace to form crystallized LFP particles, performing a post-treatment on the crystallized LFP particles to control a particle size distribution of the crystallized LFP particles, and applying a conductive carbon coating on the crystallized LFP particles to form the LFP cathode material.

### TECHNICAL FIELD

The present invention relates to lithium iron phosphate (LFP) cathode materials for lithium-ion batteries. More specifically, the invention pertains to a liquid-free synthesis method of an LFP cathode material utilizing resonant acoustic mixing (RAM) technology, an LFP cathode material synthesized via the method, as well as the application of such LFP cathode material in electric vehicles and energy storage systems.

### BACKGROUND

Lithium iron phosphate (LFP) has gained widespread adoption as a cathode material in lithium-ion batteries due to its superior thermal stability, long cycle life, and safety characteristics. However, conventional LFP synthesis methods are often water-and energy-intensive, leading to higher costs and environmental concerns.

### SUMMARY

The present invention overcomes the above challenges by introducing a liquid-free, dry-process synthesis method that employs resonant acoustic mixing (RAM) technology to enhance efficiency, sustainability, and battery performance.

In a first aspect, the present invention provides a method for liquid-free synthesis of an LFP cathode material based on RAM technology, including: providing precursor materials including lithium carbonate, iron phosphate, and a carbon source, mixing and pulverizing the precursor materials using a resonant acoustic mixer without employing a liquid medium, performing a heat treatment on pulverized precursor materials in a nitrogen-atmosphere furnace to form crystallized LFP particles, performing a post-treatment on the crystallized LFP particles to control a particle size distribution, and applying a conductive carbon coating on the crystallized LFP particles to form the LFP cathode material.

Further, in the precursor materials, the lithium carbonate (Li₂CO₃) has a purity of greater than or equal to 99.5 wt. %, and the carbon source is selected from glucose, fructose, glyceraldehyde, sucrose, citric acid, lactose, and maltose.

Optionally, the precursor materials may further include a dispersant and an additive, the dispersant can be polyethylene glycol (PEG), and the additive can be one or more selected from carbon black, graphite, titanium dioxide, ammonium metavanadate, and niobium pentoxide.

Further, in the precursor materials, an iron-to-phosphorus atomic ratio ranges from 0.955 to 0.968, a lithium-to-iron atomic ratio ranges from 1.018 to 1.025, a carbon content ranges from 1.0% to 1.5% by weight, and optionally a content of the additive ranges from 0.1% to 0.4% by weight.

Further, the precursor materials are mixed and pulverized based on the RAM technology via the resonant acoustic mixer under the following parameters of the RAM technology: a controlled acceleration force up to 100 g, preferably 30 g to 100 g, a vibration frequency ranging from 10 Hz to 60 Hz, and a duration ranging from 1 minute to 20 minutes.

Further, the heat treatment is carried out at a temperature ranging from 300 °C to 800 °C in a controlled nitrogen atmosphere.

Further, the heat treatment includes a first-stage sintering process and a second-stage sintering process, the first-stage sintering process is performed at a temperature of 300 °C to 400 °C for 1 hours to 6 hours, and the second-stage sintering process is performed at a temperature of 700 °C to 800 °C for 4 hours to 12 hours.

Further, the post-treatment includes air jet milling and sorting, and the particle size distribution of the crystallized LFP particles is controlled within a range from about 1 μm to about 9 μm.

Further, the conductive carbon coating is an amorphous carbon coating.

In a second aspect, the present invention provides an LFP cathode material for a lithium-ion battery, which is synthesized by the method described in the first aspect above. The LFP cathode material includes LFP particles, a conductive carbon coating uniformly wrapping the LFP particles, and optionally a dopant, where the LFP cathode material has a core-shell structure with the LFP particles as a core and the conductive carbon coating as a shell.

Further, the conductive carbon coating is a continuous amorphous carbon coating accounting for 1.0% to 1.5% by mass of a total mass of the LFP cathode material.

Further, in the core-shell structure, the shell coverage is greater than or equal to 95%.

Further, the LFP cathode material has a median particle size distribution (D50) of less than or equal to 2μm and a pure olivine-type crystal structure.

Further, the LFP cathode material manifests as uniform, visually homogeneous gray-black powders, and entirely free from visible particle agglomeration or inconsistent coloration.

Further, the LFP cathode material has a tap density of greater than or equal to 0.8 g/cm³, a compacted density of greater than or equal to 2.4 g/cm³, and a specific surface area measured by Brunauer-Emmett-Teller (BET) method ranging from 9.0 m²/g to 13.0 m²/g, typically around 11.0±2.0 m²/g.

Further, the LFP cathode material exhibits a low electrical resistivity of less than or equal to 30 Ω·cm, a minimal moisture content below 500 parts-per-million (ppm), and a very low magnetic impurity content below 500 parts-per-billion (ppb).

Further, the LFP cathode material consistently achieves an initial-cycle discharge capacity of greater than or equal to 150 milliampere-hours per gram (mAh/g) at 0.1 C, accompanied by coulombic efficiency—defined herein as the ratio of discharge capacity to charge capacity—typically at or above 96%.

Further, the dopant can be one or more selected from carbon black, graphite, titanium dioxide, ammonium metavanadate, and niobium pentoxide.

Further, the LFP cathode material has a cycle life of at least 20 years.

In a third aspect, the present invention provides applications of the LFP cathode material described in the second aspect above. The LFP cathode material is particularly suited for applications in electric vehicles and stationary energy storage systems, where efficiency, sustainability, and cost-effectiveness are paramount.

The present invention addresses long-standing limitations of conventional LFP manufacturing by eliminating water usage and significantly lowering energy consumption.

Compared with the prior art, the present invention has the following technical effects/advantages:

The innovative liquid-free synthesis method described herein eliminates the need for water or other liquid media typically used in conventional LFP cathode material manufacturing processes. Traditional synthesis methods require extensive use of water-based or other liquid solvents for precursor mixing, grinding, dispersion, and subsequent drying steps, leading to higher production complexity, energy consumption, and environmental concerns related to wastewater disposal. In contrast, the dry-process method described herein circumvents these water-intensive steps entirely, resulting in significant reductions in energy consumption and production-related waste, thereby offering a more sustainable and environmentally friendly production route.

Moreover, this liquid-free manufacturing approach dramatically reduces production costs by up to 85% due to the elimination of multiple wet-processing steps, lower energy requirements, simplified equipment configuration, and reduced infrastructure needed for water handling, treatment, and disposal. Simultaneously, by employing the RAM technology, the processing time required for mixing, pulverizing, and homogenizing the precursor materials is shortened by more than 90%, substantially improving manufacturing throughput and operational efficiency.

Additionally, the absence of liquid media during mixing minimizes potential contamination risks and impurities, leading to a cathode material with significantly enhanced purity and structural consistency. This improved purity directly translates into superior electrochemical performance, including increased capacity density and stability. The precise control afforded by the RAM technology facilitates uniform particle size distribution at the micron level, thereby enhancing the consistency of particle characteristics across batches. This highly uniform particle size distribution and optimized particle morphology further contribute to achieving greater energy density, improved electrical conductivity, and increased overall performance reliability of the synthesized LFP cathode materials.

Finally, these advantages collectively extend the effective battery cycle life from the conventional standard of approximately 10 years up to potentially 20 years. Such remarkable improvement in lifespan directly enhances the economic viability and performance reliability of lithium-ion batteries used in demanding applications such as electric vehicles and large-scale stationary energy storage systems, thereby providing substantial long-term benefits to users and manufacturers alike.

### BRIEF DESCRIPTION OF THE DRAWINGS

FIG. 1A illustrates a flowchart showing the conventional wet process.

FIG. 1B illustrates a flowchart showing the liquid-free, dry-process synthesis method of the present application.

FIGS. 2A-2B illustrate the state of the precursor materials before mixing through dry process (FIG. 2A) and after mixing through dry process for five minutes (FIG. 2B).

FIGS. 3A-3D illustrate scanning electron microscope (SEM) images of the precursor materials treated by dry process (FIGS. 3A and 3B) vs. conventional wet process (FIGS. 3C and 3D).

FIGS. 4A-4B illustrate an SEM image (FIG. 4A) and a particle size distribution (FIG. 4B) of the LFP cathode material synthesized via the liquid-free, dry-process synthesis method of the present application.

FIG. 5 illustrates X-ray diffraction (XRD) patterns of the LFP cathode material synthesized via the liquid-free, dry-process synthesis method of the present application and the conventional wet process.

FIG. 6 illustrates initial-cycle charge and discharge curves of an LFP half-cell where LFP is synthesized via the liquid-free, dry-process synthesis method of the present application.

FIG. 7 illustrates cycle performance of the LFP half-cell at C/3 charge/discharge rate where LFP is synthesized via the liquid-free, dry-process synthesis method of the present application.

FIG. 8 illustrates cycle performance (C/3 discharge) of the LFP half-cell where LFP is synthesized via the liquid-free, dry-process synthesis method of the present application and an LFP half-cell where LFP is synthesized via the conventional wet process.

FIG. 9 shows the comparison of electrochemical performance of the LFP cathode materials synthesized in Example 1 and Comparative Example 2 (Control).

FIG. 10 is XRD patterns of the standard LFP, the LFP cathode material synthesized in Example 1, and the LFP cathode material synthesized in Comparative Example 3.

FIG. 11 shows the comparison of particle size distribution of the LFP cathode materials synthesized in Example 1 and Comparative Example 4 (Control).

FIG. 12 shows the comparison of cycle performance of batteries using the LFP cathode materials synthesized in Example 1 and Comparative Example 5 (Control).

### DETAILED DESCRIPTION OF THE EMBODIMENTS

The present application relates to a liquid-free synthesis method of an LFP cathode material utilizing RAM technology, an LFP cathode material synthesized via the method, as well as the application of such LFP cathode material in electric vehicles and energy storage systems. A cathode material is a crucial electrode component that determines the performance, capacity, lifespan, and safety of a lithium-ion battery. LFP is widely recognized in battery technology due to several intrinsic advantages: notably its remarkable thermal stability, chemical safety, excellent structural stability during cycling, and long cycle lifespan. These properties make LFP an ideal material for applications requiring consistent, safe, and reliable energy storage, such as electric vehicles (EVs), hybrid-electric vehicles (HEVs), plug-in hybrid electric vehicles (PHEVs), stationary power storage for renewable energy integration, grid-scale energy storage, emergency power systems, telecommunications backup power, and industrial energy storage applications.

Despite the above-mentioned advantages, existing technologies for synthesizing an LFP cathode material primarily rely on wet grinding and slurry-based processes. “Wet grinding” refers to conventional methods in which solid precursor materials are dispersed in water or other liquid solvents and then mechanically processed using techniques such as ball milling, bead milling, planetary milling, etc. These wet techniques inherently possess several critical drawbacks, including extensive water consumption, substantial energy requirements for subsequent drying processes, and complicated wastewater treatment processes required due to slurry processing. Additionally, traditional wet methods typically demand prolonged processing times, commonly exceeding 20 to 24 hours, to adequately disperse, mill, dry, and granulate precursor materials. The resulting cathode powders often suffer from non-uniform particle sizes, particle agglomeration, impurities, and compromised electrochemical performance, including limited specific capacity, reduced cycle life, and higher internal electrical resistance due to uneven carbon coating coverage and poor particle uniformity.

To tackle such problems, the present application provides an innovative and comprehensive solution by introducing a novel, entirely liquid-free method for synthesizing an LFP cathode material utilizing RAM technology. RAM technology is a state-of-the-art dry mixing technology that utilizes acoustic energy—high-intensity, low-frequency mechanical vibrations—to induce vigorous and uniform mixing without the need for mechanical blades, impellers, or grinding media. RAM technology achieves uniform dispersion, particle-size reduction, and material homogenization simultaneously by inducing acoustic waves in the precursor particles. Unlike conventional mechanical mixing methods, RAM does not rely on direct physical contact or frictional abrasion, thus greatly reducing the risk of particle contamination and preserving the integrity of high-purity cathode materials.

### Example 1

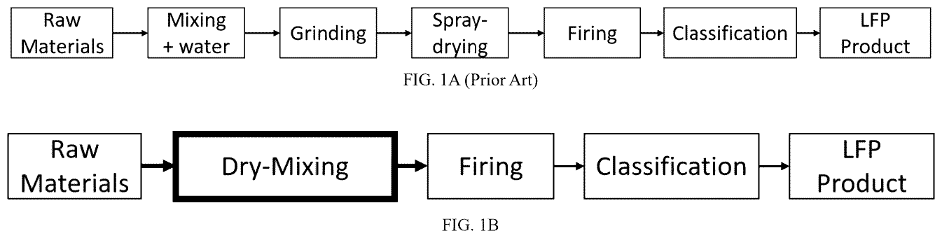

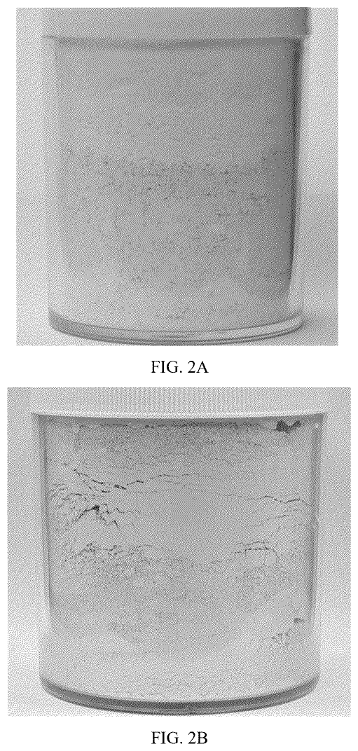

A liquid-free, dry-process synthesis method of an LFP cathode material is shown in FIG. 1B.

16.3±0.2 wt. % of lithium carbonate, 65.5±0.2 wt. % of iron phosphate, 10.0±0.5 wt. % of a carbon source (i.e., glucose), 6.5±0.5 wt. % of a dispersant (optional), and 1.7±0.2 wt. % of an additive (optional) are taken as precursor materials, where in the precursor materials, an iron-to-phosphorus atomic ratio ranges from 0.955 to 0.968, a lithium-to-iron atomic ratio ranges from 1.018 to 1.025, and a carbon content ranges from 1.0 % to 1.5 % by weight. The precise control of these value ranges of the precursor materials is crucial to enhance electrochemical performance, structural integrity, and cycle stability.

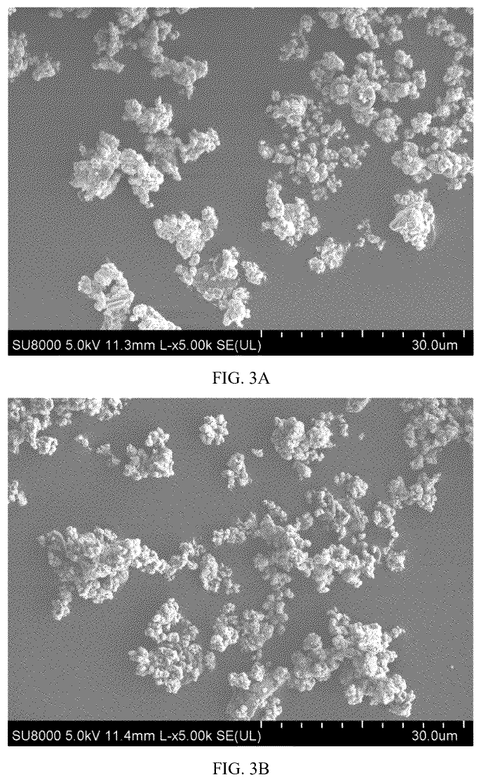

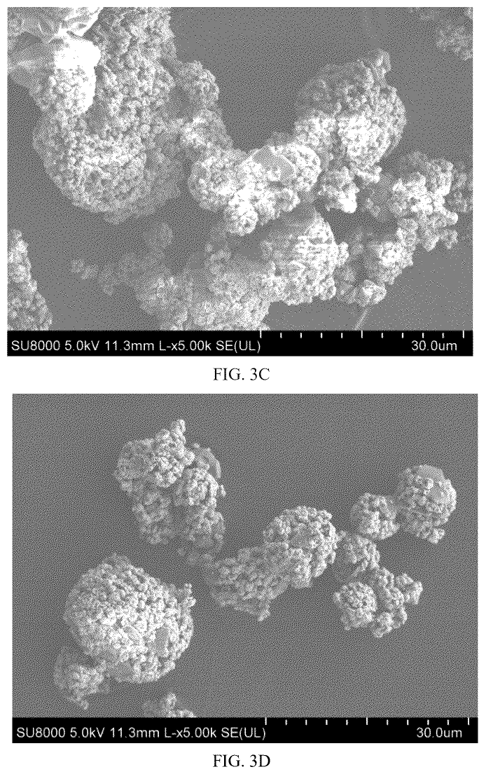

The precursor materials are mixed and pulverized using a resonant acoustic mixer without employing a liquid medium to obtain pulverized precursor materials, where the resonant acoustic mixer is set to operate under the following parameters: a controlled acceleration force ranging from 30 g to 100 g, a vibration frequency ranging from 10 Hz to 60 Hz, and a duration ranging from 1 minute to 20 minutes. The state of the precursor materials before and after mixing is shown in FIGS. 2A-2B. The SEM images of the precursor materials after mixing for 5 minutes are shown in FIGS. 3A-3B. This single, rapid mixing step using the resonant acoustic mixer substantially streamlines the traditional multi-step wet processes—such as slurry preparation, wet grinding, drying, granulation, and sieving—into one efficient and simplified operation, dramatically reducing total production time, manufacturing complexity, and associated operational costs.

The pulverized precursor materials are subjected to a first-stage sintering process and a second-stage sintering process in a nitrogen-atmosphere furnace to form crystallized LFP particles, where the first-stage sintering process is performed at a temperature of 300 °C to 400 °C for 1 hours to 6 hours, and the second-stage sintering process is performed at a temperature of 700 °C to 800 °C for 4 hours to 12 hours. These precise heat-treatment conditions ensure the synthesized lithium iron phosphate cathode particles possess the desired crystalline structure, electrochemical stability, and enhanced particle uniformity. The nitrogen atmosphere is specifically maintained to prevent oxidation reactions, contamination, and impurities formation during the sintering process, thus ensuring purity and optimal crystallization of lithium iron phosphate particles. The first-stage sintering process promotes solid-state reactions among precursors, partial carbonization of the carbon sources, and initial crystallization, and the second-stage sintering process promotes formation and crystallization of LFP particles, develops optimal crystalline structure, and enhances particle density and uniformity.

The crystallized LFP particles are subjected to precise particle size adjustment and classification through advanced air jet milling and sorting techniques and then deposition of an amorphous carbon coating to obtain the LFP cathode material. Air jet milling is a method employing compressed air streams to accelerate particles rapidly, causing controlled inter-particle collisions that precisely reduce particle size without introducing impurities or contamination. The target median particle size distribution (D50) after air jet milling is typically controlled at approximately 2 μm or less. Achieving precise particle size control significantly improves particle mono-dispersity, reduces particle agglomeration, and promotes uniform electrode coating characteristics, thereby enhancing cathode electrochemical performance, energy density, and battery cycling stability.

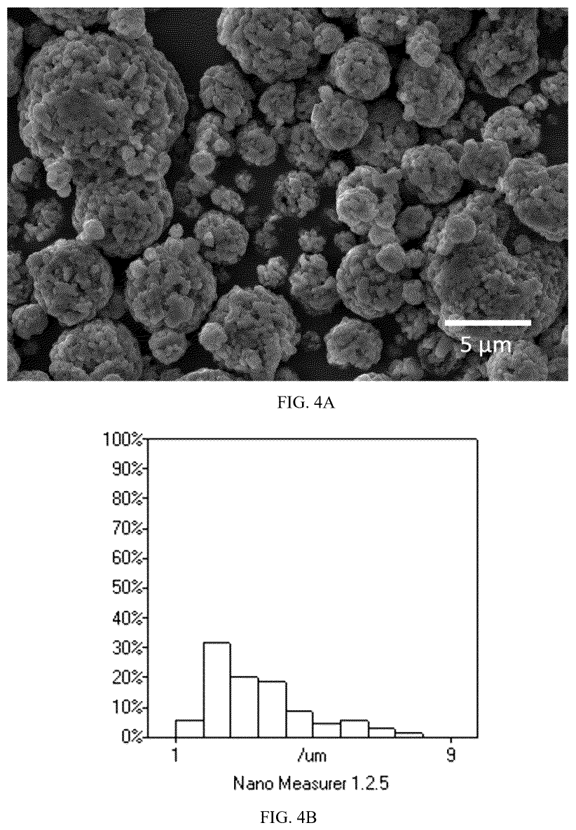

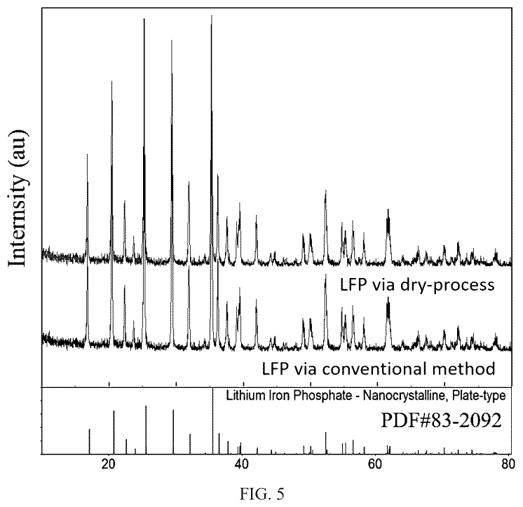

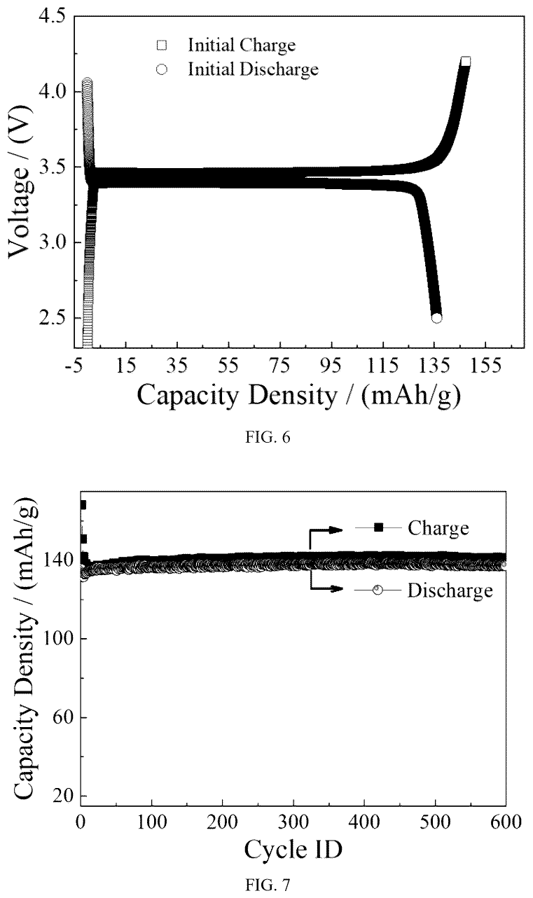

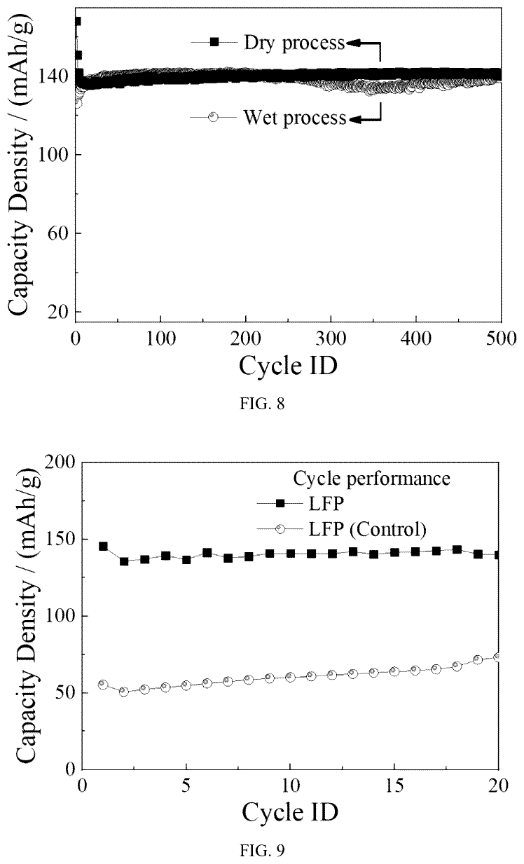

The LFP cathode material obtained has a core-shell structure with the crystallized LFP particles as a core and the amorphous carbon coating as a shell, and in the core-shell structure, a shell coverage of the shell is greater than or equal to 95%. The LFP cathode material has a particle size distribution of 1 μm to 9 μm, as shown in FIGS. 4A-4B. The XRD pattern of the LFP cathode material is shown in FIG. 5. An LFP half-cell using the LFP cathode material is subjected to an initial-cycle charge and discharge testing, and the results are shown in FIG. 6. A clear charge-discharge platform is presented within the range of 3.3-3.5 V, indicating that the material has a typical olivine crystal structure and the lithium ion deintercalation reaction is highly reversible. Dry-process LFP has better crystal structure integrity and lithium-ion diffusion efficiency. The LFP cathode material has an initial-cycle discharge capacity of greater than or equal to 150 mAh/g at 0.1 C (a current rate corresponding to a ten-hour battery discharge cycle) and a coulombic efficiency at or above 96%. FIG. 7 shows dry-process LFP exhibits a more gentle capacity decay trend in conventional cycles, especially in the later stage of long cycles. FIG. 8 demonstrates the dry process avoids particle agglomeration and impurity residue caused by the wet process, maintaining higher structural stability in long cycles. The dry process shows a capacity retention rate significantly better than that of conventional processes, proving that its structural stability and anti-attenuation ability are better.

Comparative Example 1

Comparative Example 1 differs from Example 1 only in that the resonant acoustic mixer is not used, instead, the precursor materials are mixed and pulverized through traditional wet grinding, as shown in FIG. 1A. The SEM images of the precursor materials after mixing through traditional wet grinding are shown in FIGS. 3C-3D. The XRD pattern of the LFP cathode material is shown in FIG. 5.

The use of RAM technology eliminates the need for any water or liquid solvents, which directly addresses environmental and economic limitations of traditional wet processes. By completely removing water from the synthesis process, the disclosed method significantly reduces both energy and resource consumption. Specifically, energy-intensive drying processes necessary in conventional wet synthesis methods are entirely eliminated, drastically decreasing the total energy expenditure and significantly reducing the carbon footprint associated with cathode manufacturing.

RAM technology significantly can enhance precursor particle dispersion uniformity, achieving particle-size consistency at the micron scale. “Micron-scale dispersion” herein refers to particle distributions where most particles are uniformly dispersed, typically within size ranges of approximately 1 to 5 microns (μm). This high uniformity at micron-scale significantly improves cathode particle consistency, prevents agglomeration—an undesirable condition where particles adhere together, reducing surface area and limiting electrochemical efficiency—and ensures consistent, smooth carbon coating coverage during subsequent heat treatment processes.

Due to the efficient and controlled nature of RAM technology, the total synthesis time required to produce LFP cathode material can be reduced from traditional durations exceeding 24 hours down to approximately 1 to 20 minutes. This exceptional efficiency increase can significantly reduce labor costs, equipment depreciation, operational complexity, and overall manufacturing expenses. As a result, cathode production costs can be reduced by approximately 85 percent compared to traditional wet methods, significantly lowering total lithium-ion battery cell production costs by approximately 9 percent. Such cost reduction can make lithium-ion batteries significantly more competitive and economically viable, particularly within the expanding market for electric vehicles and grid-scale energy storage solutions.

### Comparative Example 2

Comparative Example 2 differs from Example 1 only in that no carbon source is added. Results shown that the resulting LFP cathode material has an initial-cycle discharge capacity of far less than 100 mAh/g at 0.1 C. The core reason is the lack of carbon source leads to the inability of Fe³⁺ to be completely reduced to Fe²⁺ and the failure of carbon coating on particles, which, consequently, compromises electrochemical performance. In conclusion, the components of the precursor materials of Example 1 are essential to the synthesis of high-purity olivine type LFP material, the lack of carbon source may lead to impurity phase and affect electrochemical performance, as shown in FIG. 9.

### Comparative Example 3

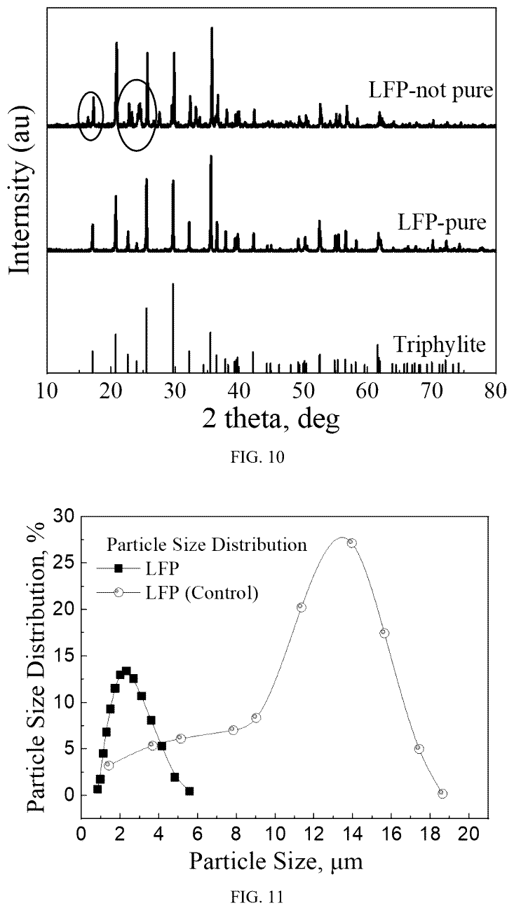

Comparative Example 3 differs from Example 1 only in that in the precursor materials, a lithium-to-iron atomic ratio is 1.0. XRD pattern in FIG. 10 shows that the LFP cathode material synthesized in Comparative Example 3 has impurities including Li₄P₂O₇ (peaks at 18, 20, 34), Li₃PO₄ (peaks at 22, 26-28, 33), Fe₃O₄ (peaks at 31, 42, 53), and Fe₂P (peak at 40.5), leading to performance decrease.

### Comparative Example 4

Comparative Example 4 differs from Example 1 only in that the resonant acoustic mixer is set to operate under the following parameters: a controlled acceleration force of less than 30 g, a vibration frequency of less than 10 Hz, and a duration of less than 1 minute. FIG. 11 shows that the LFP cathode material synthesized in Comparative Example 4 has significantly larger particle size than that synthesized in Example 1.

### Comparative Example 5

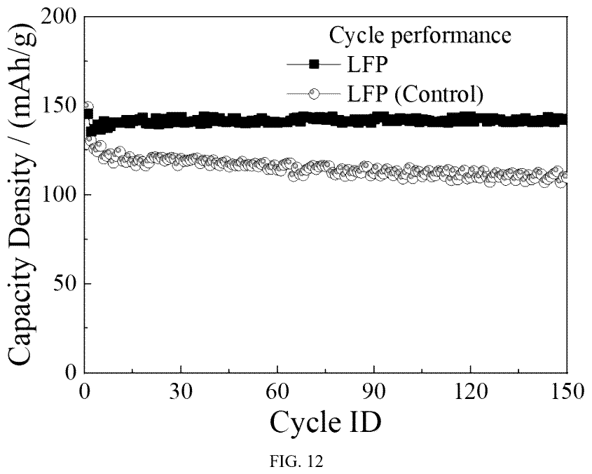

Comparative Example 5 differs from Example 1 only in that in the precursor materials, a carbon content is 0.5 wt. % and the resonant acoustic mixer is set to operate under the following parameters: a controlled acceleration force of less than 30 g, a vibration frequency of less than 10 Hz, and a duration of less than 1 minute. Results show that the insufficient mixing conducted under the condition set in Comparative Example 5 leads to nonuniform distribution of carbon source, and the insufficient carbon content leads to a shell coverage of far less than 90%, as shown in FIG. 12. In conclusion, the RAM parameters and the carbon content in Example 1 exhibit a synergistic effect of achieving a shell coverage of greater than or equal to 95% which is a direct and critical factor for improving battery performance.

### Example 2

Example 2 differs from Example 1 only in that any of fructose, glyceraldehyde, sucrose, PEG, citric acid, lactose, and maltose is used instead of glucose as a carbon source. Same results are obtained as those shown in Example 1.

In the above examples and comparative examples, the carbon source serves dual roles as reductants during heat treatment and as precursors for forming conductive carbon coatings on LFP particles, significantly enhancing electronic conductivity. Additionally, PEG acts as a dispersant—a substance used to facilitate even distribution and particle separation—to enhance handling, mixing, and particle uniformity.

In the above examples and comparative examples, specific additives can also be introduced into precursor mixtures to improve cathode performance further. Suitable additives include carbon black, graphite, titanium dioxide, ammonium metavanadate, and niobium pentoxide. The content of the additive can be approximately 0.1 to 0.4 by weight. These additives improve electrical conductivity, thermal stability, electron transfer, and cathode structural integrity, directly enhancing battery performance and extending cycle lifespan.

In the above examples and comparative examples, the initial raw material preparation involves finely powdering each precursor compound separately to ensure optimal particle size uniformity. This preliminary powdering process is crucial for achieving consistent particle sizes and distributions, directly influencing the cathode performance. Once finely powdered, precursor materials are loaded into specialized containers designed explicitly for use with RAM technology.

The LFP cathode material synthesized by the method of the present application manifests as uniform, visually homogeneous gray-black powders, entirely free from visible particle agglomeration or inconsistent coloration. Powder properties include precisely controlled tap density typically greater than or equal to approximately 0.8 g/cm³, compacted density typically greater than or equal to approximately 2.4 g/cm³, and specific surface area measured by BET method ranging approximately from 9.0 to 13.0 m²/g, typically around 11.0±2.0 m²/g. The powders exhibit low electrical resistivity of typically less than approximately 30 Ω·cm, minimal moisture content consistently below approximately 500 ppm, and very low magnetic impurity content (below approximately 500 ppb). These optimized physical characteristics collectively enhance electrode coating efficiency, packing density, electrochemical reliability, performance stability, and operational lifespan within battery cells.

The substantial reductions in processing time, production complexity, environmental impact, water and energy consumption, and manufacturing costs provided by the disclosed RAM-based dry method collectively represent a transformative advancement over existing LFP cathode manufacturing processes. Specifically, eliminating water entirely from the synthesis method drastically reduces environmental impacts associated with wastewater treatment, minimizes energy-intensive drying procedures, significantly reduces energy-related carbon emissions, and considerably enhances manufacturing sustainability.

The reduced production costs, accelerated production timelines, and improved electrochemical performance directly enhance the economic viability and market competitiveness of lithium-ion battery technologies, particularly within expanding applications in electric vehicles, renewable energy storage systems, stationary storage systems, and grid-scale battery installations. These collective improvements substantially promote lithium-ion battery adoption globally, enabling broader, economically sustainable integration of advanced battery technologies into diverse energy management applications.

The advanced RAM-based dry synthesis technology described herein offers lithium-ion battery manufacturers significant flexibility, rapid scalability, and ease of adaptation to evolving market requirements and regulatory frameworks. Specifically, the simplified and efficient RAM mixing and pulverization processes allow rapid scaling of production capacities, promoting agile and cost-effective responses to market demands for high-performance lithium iron phosphate cathodes. This flexibility directly supports industry-wide efforts to transition rapidly toward sustainable, efficient, and environmentally friendly battery manufacturing practices.

The inventive methods disclosed herein represent a transformative advancement in cathode material production technology, leveraging RAM technology to achieve unprecedented levels of electrochemical performance, cost-effectiveness, environmental sustainability, and manufacturability. This breakthrough enables the lithium-ion battery industry to significantly improve battery cycle life, specific capacity, energy density, reliability, and economic competitiveness, directly contributing to a global shift toward clean, renewable, and sustainable energy storage solutions.

What is claimed is:

1. A method for liquid-free synthesis of a lithium iron phosphate (LFP) cathode material based on resonant acoustic mixing (RAM) technology, comprising:
providing precursor materials comprising lithium carbonate, iron phosphate, and a carbon source;
mixing and pulverizing the precursor materials using a resonant acoustic mixer without employing a liquid medium;
performing a heat treatment on pulverized precursor materials in a nitrogen-atmosphere furnace to form crystallized LFP particles;
performing a post-treatment on the crystallized LFP particles to control a particle size distribution of the crystallized LFP particles; and
applying a conductive carbon coating on the crystallized LFP particles to form the LFP cathode material.

2. The method according claim 1, wherein in the precursor materials, the lithium carbonate (Li₂CO₃) has a purity of greater than or equal to 99.5%, and the carbon source is selected from glucose, fructose, glyceraldehyde, sucrose, citric acid, lactose, and maltose.

3. The method according claim 1, wherein the precursor materials further comprise a dispersant and an additive, the dispersant is polyethylene glycol (PEG), and the additive is one or more selected from carbon black, graphite, titanium dioxide, ammonium metavanadate, and niobium pentoxide.

4. The method according claim 1, wherein in the precursor materials, an iron-to-phosphorus atomic ratio ranges from 0.955 to 0.968, a lithium-to-iron atomic ratio ranges from 1.018 to 1.025, and a carbon content ranges from 1.0% to 1.5% by weight.

5. The method according claim 3, wherein a content of the additive ranges from 0.1% to 0.4% by weight.

6. The method according claim 1, wherein the precursor materials are mixed and pulverized based on the RAM technology via the resonant acoustic mixer under the following parameters of the RAM technology: a controlled acceleration force up to 100 g, a vibration frequency ranging from 10 Hz to 60 Hz, and a duration ranging from 1 minute to 20 minutes.

7. The method according claim 6, wherein the controlled acceleration force ranges from 30 g to 100 g.

8. The method according claim 1, wherein the heat treatment is carried out at a temperature ranging from 300°C to 800°C in a controlled nitrogen atmosphere.

9. The method according claim 8, wherein the heat treatment comprises a first-stage sintering process and a second-stage sintering process, the first-stage sintering process is performed at a temperature of 300°C to 400°C for 1 hours to 6 hours, and the second-stage sintering process is performed at a temperature of 700°C to 800°C for 4 hours to 12 hours.

10. The method according claim 1, wherein the post-treatment comprises air jet milling and sorting, and the particle size distribution of the crystallized LFP particles is controlled within a range from about 1 μm to about 9 μm.

11. The method according claim 1, wherein the conductive carbon coating is an amorphous carbon coating.

12. An LFP cathode material for a lithium-ion battery, synthesized by the method according to claim 1, comprising: the crystallized LFP particles and the conductive carbon coating uniformly wrapping the crystallized LFP particles, wherein the LFP cathode material has a core-shell structure with the crystallized LFP particles as a core and the conductive carbon coating as a shell.

13. The LFP cathode material according to claim 12, further comprising a dopant.

14. The LFP cathode material according to claim 12, wherein the conductive carbon coating is a continuous amorphous carbon coating accounting for 1.0% to 1.5% by mass of a total mass of the LFP cathode material.

15. The LFP cathode material according to claim 12, wherein in the core-shell structure, a shell coverage of the shell is greater than or equal to 95%.

16. The LFP cathode material according to claim 12, wherein the LFP cathode material has a median particle size distribution (D50) of less than or equal to 2μm and a pure olivine-type crystal structure.

17. The LFP cathode material according to claim 12, wherein the LFP cathode material has a tap density of greater than or equal to 0.8 g/cm³, a compacted density of greater than or equal to 2.4 g/cm³, and a specific surface area measured by a Brunauer-Emmett-Teller (BET) method ranging from 9.0 m²/g to 13.0 m²/g.

18. The LFP cathode material according to claim 12, wherein the LFP cathode material exhibits a low electrical resistivity of less than or equal to 30 Ω·cm, a minimal moisture content below 500 parts-per-million (ppm), and a very low magnetic impurity content below 500 parts-per-billion (ppb).

19. The LFP cathode material according to claim 12, wherein the LFP cathode material has an initial-cycle discharge capacity of greater than or equal to 150 milliampere-hours per gram (mAh/g) at 0.1C and a coulombic efficiency at or above 96%.

20. The LFP cathode material according to claim 12, wherein the LFP cathode material is configured to be integrated into the lithium-ion battery used in an electric vehicle or a stationary energy storage system.
